(19) United States
(12) Patent Application Publication
(10) Pub. No.: US 2003/0043043 A1
(43) Pub. Date: Mar. 6, 2003

(54) System and method for automatic animal weighing during injection administration

(76) Inventor: Thomas Hogan, Powder Springs, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/205,404

(22) Filed: Jul. 24, 2002

Related U.S. Application Data
(63) Continuation-in-part of application No. 10/178,943, filed on Jun. 24, 2002.
Application No. 10/178,943 is a continuation-in-part of application No. 09/832,385, filed on Apr. 11, 2001.
Application No. 10/178,943 is a continuation-in-part of application No. 10/128,132, filed on Apr. 23, 2002.
Application No. 10/128,132 is a continuation-in-part of application No. 10/093,856, filed on Mar. 7, 2002.
Application No. 10/093,856 is a continuation-in-part of application No. 09/477,262, filed on Jan. 4, 2000, now Pat. No. 6,401,071.

(51) Int. Cl. G08B 23/00

(52) U.S. Cl. 340/573.3; 340/5.8; 340/666

(57) ABSTRACT

A system and method for automatic animal weighing during delivery of injections to animals are accomplished by a transmitting scale head transmitting the weight of an animal after the animal is weighed by an electronic scale. A transmitting syringe reads the transmitted weight information and links it with other information relating to the injection, such as the identity of the animal and the nature of the injection to create “event information”. The event information is stored for examination and analysis.

### RELATED APPLICATIONS

This application is a continuation-in-part of pending U.S. patent application Ser. No. 10/178,943, filed Jun. 24, 2002, entitled “System and Method for Automatic Redundant Recording of Animal Injection Information,” which is a continuation-in-part of pending U.S. patent application Ser. No. 09/832,385, filed Apr. 11, 2001, and entitled “Tamper-Proof Animal Identification Tag,” and U.S. patent application Ser. No. 10/128,132, filed Apr. 23, 2002, and entitled “System and Method for Automatically Recording Animal Temperature and Vaccination Information, which is a continuation-in-part of U.S. patent application Ser. No. 10/093,856, filed Mar. 7, 2002, which is a continuation-in-part of U.S. Pat. No. 6,401,071, filed Jan. 4, 2000, which are both entitled “System and Method for Automatically Recording Animal Injection Information.”

### TECHNICAL FIELD

The present invention relates to systems and methods for automatically weighing and wirelessly recording the animal's weight during the administration of an injection, and then associating the weight information with other information relating to the injection.

### BACKGROUND INFORMATION

The regular and accurate tracking of information relating to food animals is well known to be critical to the health and value of the animals. With this in mind, recent years have ushered in systems specifically developed to provide ranchers with viable mechanisms to improve the process of administering medicine injections to their animals. For example, my U.S. Pat. No. 5,961,494, which is specifically incorporated herein by reference, discloses a marking syringe which, when actuated, simultaneously injects medicine into an animal and places a mark on the skin of the animal in proximity to the location of the injection. This marking syringe (known commercially as the “VAC-MARC”, marketed by Prima Tech, U.S.A., www.primatechusa.com) cleverly reduces what was formerly a clumsy, two-step injecting and marking process into one step—the actuation of the syringe. Nonetheless, a cattleman using the marking syringe taught by the '494 patent and desiring to maintain records of injections would still have to somehow identify the animal and then manually record the fact that that particular animal had been injected.

Beyond the logistics of injecting and marking an animal, proper identification of the animal is also important. In this regard, my U.S. Pat. No. 6,401,071, which is specifically incorporated herein by reference, discloses a revolutionary system and method for automatically ascertaining the identity of an animal upon delivery of an injection to the animal, and recording both the identity of the animal and the occurrence of the injection in a computer database.

While such a system was revolutionary, it was soon further improved upon by a system and method for recording “event information” (information relating to the identity of the animal and information relating to the injection of the animal) onto a read/write radio frequency identification device (“RWRFID”) as well as in a computer database, as described in my pending U.S. application Ser. No. 10/178,943 which is specifically incorporated herein by reference.

Even with these vast improvements, systems for collecting and storing information relating to food animals can be improved. More specifically, no systems currently exist which record the above-specified information, along with automatically and wirelessly recording perhaps the single most important bit of data relating to any food animal . . . its weight.

Accordingly, there is a need for a system and method which provide for the automatic collection and recordation of the weight of an animal at the time of an injection.

There is a further need for a system and method satisfying the foregoing need without adding troublesome additional cords or wires to an injection arena.

Finally, there is a need for such a system and method which associates information gathered regarding the weight of the animal with other information gathered regarding the identity of the animal and the injection given to the animal.

### BRIEF SUMMARY OF THE INVENTION

The present invention relates to a system and method for automatically recording the weight of an animal during administration of an injection to the animal. An embodiment of the system comprises, generally, an electronic scale for generating weight information including a weight of an animal and a scale head, communicatively interconnected to the electronic scale, for receiving the weight information of the animal.

A transmitter is communicatively interconnected to the scale head, and periodically transmits the weight information to a transceiver that may be interconnected to a syringe, which is operative to receive identification information from the animal and the weight information of the animal. The transceiving syringe is further operative to associate the identification information and the weight information with injection information relating to an injection of the animal into “event information.” The transceiving syringe then relays the event information to a storage medium.

### BRIEF DESCRIPTION OF THE DRAWINGS

FIG. 1 depicts an exemplary embodiment of the present invention in an exemplary operating environment.

FIG. 2 is a flow diagram detailing exemplary steps in performing the method of the present invention.

### DETAILED DESCRIPTION

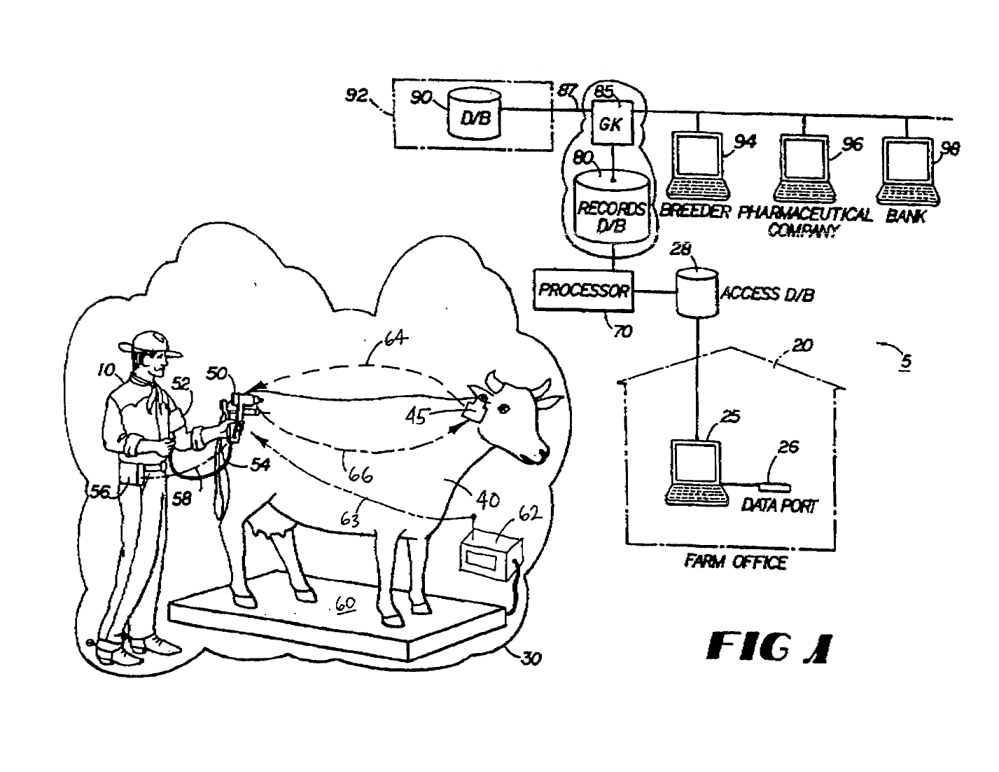

Referring now to the drawings, FIG. 1 depicts an exemplary embodiment of the present invention in an exemplary operating environment. The general principles of this operating environment are described, in detail, in the above-referenced patents and pending applications, each of which has been specifically incorporated herein by reference. For clarity, a brief description of an exemplary operating environment for the present invention follows.

The Automatic Injection Recordation System 5 (hereinafter referred to as the “System”) features logistical and procedural devices by which a cattleman 10 can operate out of a farm office 20 in a particular remote injection arena 30 to deliver injections to an animal 40 and, importantly, automatically record data—including the weight of the animal 40—using an electronic scale 60 and a transmitting scale head (“scale head”) 62.

In operation, the cattleman 10 may begin operation of the System 5 by entering identification data such as personal identification information into a personal computer (“PC”) 25 in or near his farm office 20. Depending on the desires of the system administrators, different levels and types of information may be required of the cattleman 10 before the cattleman 10 is authorized for further use of the System 5. Determination as to authorization may be made by comparison of information requested of the cattleman 10 to information maintained in a database such as the access database 28. Information contained in the access database 28 relating to authorization criteria for cattlemen could originate from any of a wide variety of sources such as a system administrator, drug manufacturer, or the like.

As far as the specifics of authorization are concerned, it may be sufficient for the cattleman 10 to enter an indicator of his personal identity, such that verification as to his training relating to the System 5 can be verified. It is understood that a substantial aspect of the value of information derived from operation of the System 5 is the guarantee that the information is devoid of errors which may originate with operation by untrained or improperly trained cattlemen. Verification that a particular cattleman has training sufficient to operate the system properly and, therefore, produce reliable data is considered valuable.

Beyond verification that a particular cattleman is properly trained for operation of the System 5, it may also be desirable to require the cattleman 10 to enter into the system, for authorization, the specific medical regimen about to be applied by the cattleman 10 to the animal 40. Determination as to what particular medical regimen is about to be applied to the animal can be made by any number of methods, including manually entering information such as the type of medicine involved, or, in more sophisticated systems, scanning with a bar-code reader a bar-code label on a particular bottle of medicine.

Clearly, if the cattleman 10 is not authorized, by virtue of a lack of training or certification, to deliver a particular medical regimen, the System 5 may not have authority to prevent such delivery. However, because of the cattleman's lack of training or certification, introduction of medical delivery information derived from the activities of an untrained cattleman into the body of data produced by the present invention may have a diminishing effect on the otherwise robust data body. In such a situation, the System 5 may simply not record data relating to medicines delivered by an improperly trained or certified cattleman. Furthermore, it will be understood and appreciated that other discriminators, above and beyond the identity and training of a particular cattleman, may be used to determine whether or not information relating to an instant medical delivery is to be introduced into the body of data.

If the cattleman 10 is authorized to use the System 5 and, additionally, meets any other criteria or discriminators put in place by the system administrator, the system may then be primed by application of electrical power to necessary subsystems and components, such as those in the injection arena 30.

In preparation for an injection session, the cattleman 10 accesses and prepares for use a syringe such as a transceiving syringe 50. The transceiving syringe 50 is a syringe which may, in one embodiment, have the ability to substantially simultaneously deliver an injection to the animal 40, deliver a marking ink spot to the animal 40, receive identification information from a RWRFID 45 attached to the animal 40, receive weight information from the electronic scale 60 via scale head 62, relay identification information relating to the animal, weight information relating to the animal, and injection information relating to the delivery of the injection to a database as “event information”, and transmit the event information to the RWRFID for storage thereon.

Many of the essential functions of the transceiving syringe 50 are known to those skilled in the prior art, in large part because of the disclosure thereof in a number of patent applications and issued patents to the inventor herein. Specifically, U.S. Pat. Nos. 5,961,494 and 6,264,637 are directed to marking syringes. U.S. Pat. No. 6,401,071 is directed to a System and Method for Automatically Recording Animal Injection Information, and fully sets forth the basic concept of simultaneously injecting an animal and recording the occurrence of the injection and the identity of the animal. Moreover, the '071 patent has given rise to multiple continuation applications, each of which have advanced the state of general knowledge regarding injection and information systems of this nature. Each of these patents and pending patent applications are specifically incorporated herein by reference.

In one embodiment of the present invention, the transceiving syringe 50 is connected to a medicine reservoir 52 via a medicine conduit 54. It is foreseen that many medical administrations will be of such a small amount, by volume, that the cattleman 10 can retain the medicine reservoir 52 on an arm, leg, or in a backpack-type retention device, for ease of mobility about the injection arena. In cases where it is not incorporated, the medicine conduit 54 is a flexible, tubular member securely interconnected between the transceiving syringe 50 and the medicine reservoir 52. As is well known to those skilled in the administration of medicines to animals, all medicine delivery components must comport with relevant health and safety regulations, especially in view of the highly toxic nature of many such medicines. In preparation for commencement of animal injections, the cattleman 10 may also place a personal data device (“PDD”) 56 on his person for recording injection information as will be described momentarily. It will also be understood that the spirit and scope of the present invention specifically contemplates transceiving syringes which, themselves, carry a sufficient amount of medicine to accomplish a desirable number of injections, without requiring either a detached medicine reservoir 52 or a medicine conduit 54.

Regarding the PDD 56, it will be understood and appreciated that the ability of the transceiving syringe 50 and the PDD 56 to collectively transmit, receive and store data can be accomplished in any of a wide variety of ways. For example, a PDD such as PDD 56 could be wholly incorporated into the transceiving syringe 50, thereby eliminating the need for a communications link 58 between the transceiving syringe 50 and a separate PDD 56. At the other extreme, all transmission and data capability could be accomplished via PDD 56, rather than have a transmitter or receiver incorporated into a syringe. In any given application, one of these embodiments may be preferable over the others, and all such embodiments are specifically contemplated within the scope of the present invention and the appended claims. For clarity and simplicity, however, only one embodiment will be fully discussed, understanding that one skilled in the art of transmitting syringes and data collection devices could easily extrapolate the principles discussed in relation thereto to other, equivalent embodiments.

Returning to the operation of the System 5, now that the System 5 is activated by registration of an authorized user such as the cattleman 10 administering a medical regimen he is authorized to administer, and the necessary medicine delivery components 50, 52 and 54 are in place, an animal 40 is moved onto an electronic scale 60 within the injection arena 30.

In an embodiment of the present invention, transmission of a stimulus signal 66 by a stimulus signal generator incorporated into the transceiving syringe 50 excites the RWRFID 45 to generate a responsive signal of identification information 64. A receiver 66 may be functionally incorporated into the transceiving syringe 50 and detects the identification information 64. After detection of the identification information 64, the transceiving syringe 50 stores the identification information 64 until the identification information 64 can be associated with injection and weight information from the event of the animal.

As the cattleman 10 delivers the injection to the animal 40 by actuating the transceiving syringe 50, an ink mark is placed on the animal 40 in close proximity to the location of the injection and, importantly, an injection information is generated by the transceiving syringe 50 which verifies that a particular injection has taken place. After the injection has taken place, the injection information and the identification information 64 are linked or “associated” into a single event information record so that a verifiable record exists which demonstrates that a particular injection was administered to a particular animal.

At approximately the same time as the animal 40 is being injected (substantially simultaneously), the weight of the animal 40 is detected by the electronic scale 60. Electronic scales are well-known in the industry, and are commercially available from a number of sources. In the present invention, the electronic scale 60 is connected to a scale head, which displays the weight of the animal. More particularly, the scale head implemented in the present invention is a transmitting scale head (hereafter simply referred to as “scale head”) 62. The scale head 62 adds the additional functionality of being able to transmit the weight of the animal wirelessly, as ascertained from the electronic scale 60, a suitable distance and at a suitable power level and frequency so as to be detected and read by the transceiving syringe 50 (or, in alternate embodiments, the PDD 56 or another receiver in the injection arena 30).

The weight information ascertained by the electronic scale 60, then transmitted as a weight information signal 63 via the scale head 62 to the transmitting syringe 50 is thereafter linked to the animal identification information and the injection information to create event information.

The mechanics of transmitting the weight information signal 63 are varied, and can be determined based on the particular needs of the cattleman 10 as well as the overall system requirements. For example, the scale head 62 may transmit the weight information signal 63 only once. In another embodiment, the scale head may transmit the weight information signal 63 repeatedly until an acknowledgement signal (not shown) is returned to the scale head 62 and detected by a scale head receiver (not shown). In yet another embodiment, the weight information signal 63 may be transmitted at a predetermined interval as long as the animal 40 remains on the electronic scale 60, meaning that when the detected weight on the electronic scale 60 drops significantly (a design parameter that can be set according to the expected weights of animals used in the System 5), the transmission of the weight information signal 63 stops. These examples of transmission schemes are, in no way, held forth as the only possible transmission schemes. Rather, they are offered as just a few of the examples of schemes that fall within the scope of the present invention and the claims appended hereto.

Once the event information has been created, it is delivered to two different locations. The event information is relayed to a computer database. It will be understood and appreciated that the term “computer database” should be broadly construed to include many forms of data storage elements capable of either short-term or long-term storage of such date. For example, a computer database may be a device such as a PDD 56 maintained on or near the person of the cattleman 10. In such a situation, the transceiving syringe 50 may be attached to the PDD 56 either by a physical connection means such as a wire or cable, or they may be wirelessly connected. In either situation, the transceiving syringe 50 relays the event information to the PDD 56 for storage until the cattleman 10 finds a convenient opportunity to connect the PDD 56 to the computer 25 by way of a data port 26 (also known as a “docking station”), from which the event information can be relayed to a remote database such as database 90, in a manner later described.

Alternately, the PDD 56 may be capable of making a direct connection (via internal modem or wireless means) to the database 90 without the need for the computer 25 or docking station 26.

Yet another iteration of this basic principle is the location of the functionality of the PDD 56 within the transceiving syringe 50 itself. In this configuration, there is no requirement for the cattleman 10 to carry an extra electrical device with him. On the other hand, adding this functionality to the transceiving syringe 50 will likely increase the weight of the syringe, possibly making this arrangement less than optimal for certain applications, as previously discussed.

In reasonable proximity, time wise, to the completion of the injection and the routing of the injection information to a computer database, the transceiving syringe 50 may also transmit the event information to the RWRFID 45 via event information signal 66. If the system 5 includes this optional functionality, the RWRFID 45 receives the event information and stores it in memory located on the RWRFID 45, itself.

As devices for transmitting, receiving and storing relatively low-power and low data content RF signals such as identification information 64 and event information signal 66 are abundantly available and well known to those skilled in the art, no further explanation of such mechanisms is needed.

Periodically, the event information gathered in accordance with the above specified system is delivered, through any of the above-discussed arrangements, through the processor 70 to a records database 80 for storage and access by authorized users. Control over access to the records database 80 is maintained by a gatekeeper 85. Gatekeepers such as gatekeeper 85 are well known in the data management industry and simply require an individual desiring access beyond the gatekeeper to provide a key, PIN, code word, or other information so that passage beyond the gatekeeper can be limited to those authorized such passage.

In one embodiment, the gatekeeper 85 is linked by a communications link 87 to the subscriber database 90 within a main office 92. The main office 92 may receive information subscription inquiries from parties desiring to be authorized parties, such as breeders 94, pharmaceutical companies 96 and banks 98. If the terms established by principals within the main office 92 are agreeable to such potential authorized parties, and if such potential authorized parties satisfy the agreed upon terms, information specific to the newly authorized party is entered into the subscription database 90. When such newly authorized party, such as a pharmaceutical company 96, for instance, attempts to access the records database 80, the gatekeeper 85 inquires as to the authority of the pharmaceutical company 96 to gain access by checking the subscriber database 90. If the pharmaceutical company 96 is an authorized subscriber, the gateway 85 permits communicative interconnection to the records database 80. Had the pharmaceutical company 96 not been determined to be an authorized user, the gateway 85 would have denied access.

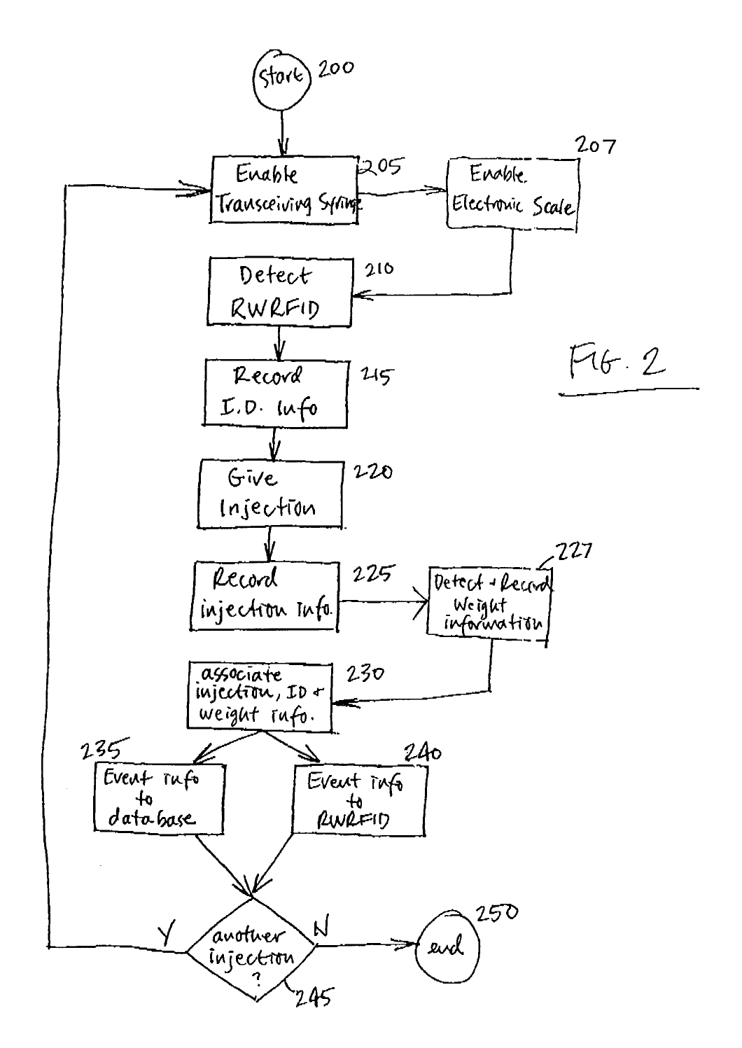

FIG. 2 depicts an exemplary method for implementation of an embodiment of the present invention. The method of FIG. 2 begins at step 200 and, at step 205, the transceiving syringe 50 is enabled. Enablement of the transceiving syringe may be, as previously described, by the cattleman 10 entering certain input, such as his identification information and the like into a computer controlling the system 5, or it may be as basic as turning on a switch on the transceiving syringe 50. In any event, the enabled transceiving syringe 50 searches for a RWRFID 45 until one is detected at step 210. At approximately the same time, the electronic scale 60 is enabled, depicted at step 207, along with the scale head 62. Upon detection of an animal 40 upon the electronic scale 60, the scale head 62 transmits a weight information signal 63.

Detection of the RWRFID 45, previously discussed, differs depending on whether the RWRFID 45 is an active or passive device. If the RWRFID 45 is an active device, the enabled transceiving syringe 50 will detect it when it comes into receiving range of the signal emitted by the RWRFID 45. If, on the other hand, it is a passive device, it will be detected when the transceiving syringe 50 comes close enough to the RWRFID 45 to excite it with a stimulus signal, then read the resulting transmission. Either way, after the RWRFID 45 has been detected, the identification information received therefrom is recorded, as shown at step 215.

At step 220, an injection is delivered from the transceiving syringe 50 to the animal 40. Substantially simultaneously to the injection at step 220 is the recording of the injection at step 225. In one embodiment of the present invention, the recording step 225 indicates a temporary recording of the injection information in a location such as a temporary memory cache within the transmitting syringe or PDD 56 by an indicator such as an audible or visual signal. At step 227, the weight information signal 63 is detected and recorded. Once the injection information and weight information have been temporarily recorded, it is, at step 230, associated (or linked) with the identification information obtained from the RWRFID 45 positively identifying the animal 40 to which the injection was given.

The method continues at step 235 where the association of the injection information and the identification information (including the weight information and referred to, collectively, as “event information”) is transmitted or relayed to a computer database such as the PDD 56. At step 240, the event information is transmitted to the RWRFID 45, where it is automatically stored in accordance with an object of the present invention.

At decision block 245, an inquiry is made as to whether another animal is to be injected. If “Yes”, the method returns to step 205 and the process is re-initiated. If “No”, the method ends at step 250.

It will be understood and appreciated that the spirit and scope of the present invention is not limited to the particular embodiments referenced and discussed herein, but to the claims appended hereto.

I claim:

1. A system for automatically recording the weight of an animal during administration of an injection to the animal, comprising:
a scale for generating weight information;
a scale head, communicatively interconnected to the scale, for receiving the weight information;
a transmitter, communicatively interconnected to the scale head, for periodically transmitting the weight information; and
a transceiving syringe operative to receive the weight information and the identification information from the animal, the transceiving syringe further operative to associate the identification information and the weight information with injection information relating to an injection of the animal into event information, the transceiving syringe still further operative to transmit the event information to a storage medium.

2. The system of claim 1, wherein the transmitter is integral to the scale head.

3. The system of claim 1, wherein the transmitter is communicatively interconnected to the scale head by a communications cable.

4. The system of claim 1, wherein the transmitter is communicatively interconnected to the scale head by wireless link.

5. The system of claim 1, wherein the transmitting syringe provides an indication upon receiving the weight information.

6. The system of claim 5, wherein the indication is an audible signal.

7. The system of claim 5, wherein the indication is a visual signal.

8. A method for automatically recording the weight of an animal during administration of an injection to the animal, comprising the steps of:
weighing an animal on a scale;
providing weight information from the scale to a scale head;
periodically transmitting the weight;
identifying the animal by detecting identification information relating to the animal;
delivering an injection to the animal by a transceiving syringe;
recording, via the transceiving syringe, injection information relating to the injection given to the animal;
receiving, via the transceiving syringe, weight information obtained at a time proximal to the injection; and
associating, as event information, the injection information relating to the injection given to the animal and the identification information relating to the animal with the weight information.

9. The method of claim 7, further comprising the step of transmitting the event information to a storage medium.

10. A method for automatically recording the weight of an animal during administration of an injection to the animal, comprising the steps of:
weighing an animal on a scale;
providing weight information from the scale to a scale head; and
responsive to a demand for the weight information subsequent to an injection of the animal, transmitting the weight information for association with information relating to the animal.

11. The method of claim 9, wherein the weight information is transmitted periodically.
